(19) United States
(12) Patent Application Publication
(10) Pub. No.: US 2022/0303340 A1
(43) Pub. Date: Sep. 22, 2022

(54) INFORMATION PROCESSING DEVICE, INFORMATION PROCESSING METHOD, AND NONTRANSITORY COMPUTER READABLE STORAGE MEDIUM

(71) Applicant: Yahoo Japan Corporation, Tokyo (JP)

(72) Inventors: Kota TSUBOUCHI, Tokyo (JP); Hidehito GOMI, Kyoto (JP); Teruhiko TERAOKA, Tokyo (JP)

(21) Appl. No.: 17/688,823

(22) Filed: Mar. 7, 2022

(30) Foreign Application Priority Data
Mar. 18, 2021 (JP) 2021-045290

(51) Int. Cl. H04L 67/12

(52) U.S. Cl. CPC H04L 67/12

(57) ABSTRACT

An information processing device according to the present application includes an acquisition unit, a determination unit, and a request unit. The acquisition unit acquires meta-information regarding sensor data from a terminal device. The determination unit determines the usefulness of the sensor data on the basis of the meta-information acquired by the acquisition unit. In a case where the determination unit determines that the sensor data is useful, the request unit requests transmission of the sensor data.

### CROSS-REFERENCE TO RELATED APPLICATIONS

The present application claims priority to and incorporates by reference the entire contents of Japanese Patent Application No. 2021-045290 filed in Japan on Mar. 18, 2021.

### BACKGROUND OF THE INVENTION

### 1. Field of the Invention

The present application relates to an information processing device, an information processing method, and an information processing program.

### 2. Description of the Related Art

Conventionally, for the purpose of improving usability of a service provided through a network, sensor data and the like including position information are collected from terminal devices owned by a large number of users. Meanwhile, from the viewpoint of privacy protection, a method of controlling exchange of information regarding an individual related to a client device has also been proposed (for example, Patent Literature 1).

However, in the conventional technology, it is difficult to selectively collect useful sensor data.

### SUMMARY OF THE INVENTION

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a diagram illustrating an example of information processing according to an embodiment;

FIG. 2 is a diagram illustrating an example of a configuration of an information processing system according to the embodiment;

FIG. 3 is a diagram illustrating an example of a configuration of an information processing device according to the embodiment;

FIG. 4 is a diagram illustrating an example of sensor data according to the embodiment;

FIG. 5 is a diagram illustrating an example of a determination condition according to the embodiment;

FIG. 6 is a flowchart illustrating an example of a processing procedure performed by the information processing device according to the embodiment; and

FIG. 7 is a hardware configuration diagram illustrating an example of a computer that implements functions of the information processing device according to the embodiment and a modified example.

### DETAILED DESCRIPTION OF THE PREFERRED EMBODIMENTS

Hereinafter, a mode (hereinafter referred to as “an embodiment”) for carrying out an information processing device, an information processing method, and an information processing program according to the present application will be described in detail with reference to the drawings. Note that the information processing device, the information processing method, and the information processing program according to the present application are not limited by the embodiment describe below. In addition, the respective embodiments described below can be appropriately combined with each other as long as processing contents do not contradict each other. In addition, in the embodiments described below, the same portions will be denoted by the same reference signs, and an overlapping description thereof will be omitted.

### 1. Overview of Information Processing

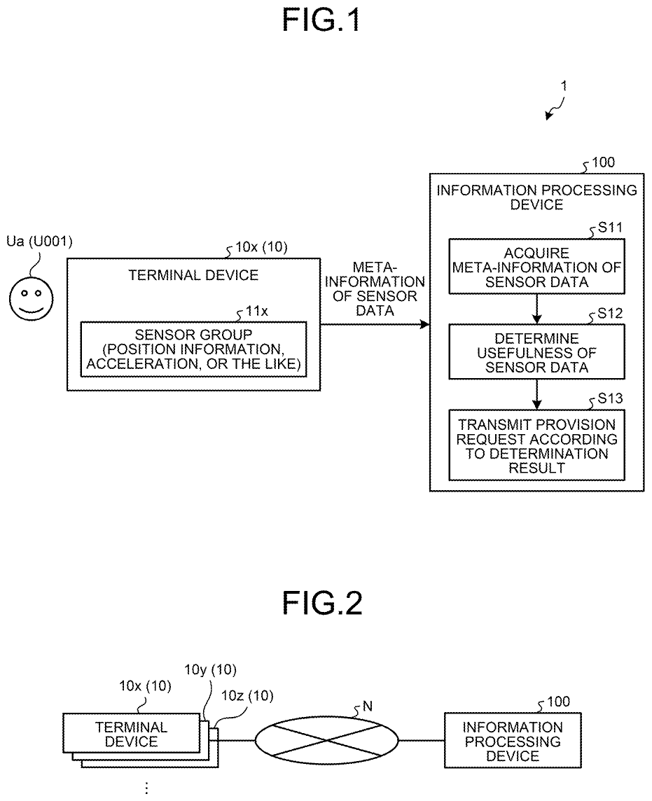

Hereinafter, an example of information processing according to an embodiment will be described with reference to the drawings. FIG. 1 is a diagram illustrating an example of information processing according to an embodiment. Note that an information processing system 1 according to an embodiment may include more terminal devices than in the example illustrated in FIG. 1. Furthermore, a user Ua is exemplified as an example of a user of a terminal device 10 in FIG. 1, but an information processing device 100 according to the embodiment can perform information processing for an arbitrary number of terminal devices and an arbitrary number of users.

As illustrated in FIG. 1, the information processing system 1 according to the embodiment includes the terminal device 10 and the information processing device 100. The terminal device 10 and the information processing device 100 can communicate with each other through a network such as the Internet.

A terminal device 10x is a terminal device used by the user Ua, and is typically a smartphone. The terminal device 10x includes a sensor group 11x. The sensor group 11x includes a global positioning system (GPS), an acceleration sensor, and the like. The sensor group 11x acquires various pieces of sensor data including position information, an acceleration, and the like.

The terminal device 10x can transmit, to the information processing device 100, meta-information regarding the sensor data acquired by the sensor group 11x. Examples of the meta-information include, in addition to date and time information (time stamp) including a date and time associated with the sensor data, various pieces of information that can be evoked as a context of the user Ua that can be acquired and determined by the terminal device 10x on the basis of sensor information, such as a location (for example, address) associated with the sensor data and a behavior state associated with the sensor data. As a specific example, a time stamp “8:00 on Tuesday, March 9” is information that can be the meta-information regarding the sensor data, an address “Kasumigaseki, Chiyoda-ku, Tokyo” is information that can be the meta-information regarding the sensor data, and a context “running along a river away from home” is also information that can be the meta-information regarding the sensor data. Furthermore, position information associated with the time stamp “8:00 on Tuesday, March 9”, an acceleration associated with the context “running along a river away from home”, and the like can be sensor data associated with the meta-information. Furthermore, the meta-information may include the type of the sensor data (the position information, the acceleration, or the like). In addition, identification information such as an identifier or a code valid only between the terminal device 10x and the information processing device 100 may be individually allocated in advance for each type of sensor data, and may be exchanged between the terminal device 10x and the information processing device 100. By doing so, it is possible to disable devices other than the terminal device 10x and the information processing device 100 from identifying that information exchanged between the terminal device 10x and the information processing device 100 is the sensor data.

The information processing device 100 is a device that collects the sensor data from the terminal device 10, and is typically a server device. Once the meta-information of the sensor data is acquired from the terminal device 10x (Step S11), the information processing device 100 determines usefulness of the sensor data associated with the meta-information on the basis of the acquired meta-information (Step S12). For example, the information processing device 100 can acquire, as the meta-information of the sensor data, various types of information that can be evoked as the context of the user Ua including a time stamp (date, time, or the like) associated with the sensor data in the terminal device 10, a location (for example, position information, map information, or an address) specified and recorded in the terminal device 10, a behavior state determined and recorded in the terminal device 10, and the like. Note that, in a case where the meta-information includes numerical values, only a difference (diff) from certain reference data may be transmitted from the terminal device 10x to the information processing device 100.

The information processing device 100 can determine the usefulness of the sensor data associated with the meta-information according to a predetermined determination condition. The usefulness determination condition can include not only a quantitative condition such as whether the amount of sensor data associated with the corresponding meta-information is large or small, whether the sensor data associated with the corresponding meta-information is old or new, whether the sensor data associated with the corresponding meta-information is rough or detailed, or whether the sensor data associated with the corresponding meta-information has high accuracy or low accuracy, but also a condition according to a demand (need) for the corresponding meta-information. Furthermore, the usefulness determination condition is not limited to a case of being defined as a statically fixed condition, and may be a condition that can be dynamically changed. For example, in a case where analysis for a certain context is required, it may be determined that usefulness of sensor data associated with the certain context is high according to an increase in demand as a data sample, and it may be determined that usefulness of sensor data having no demand as a data sample is low. Specifically, the information processing device 100 determines the usefulness of the sensor data on the basis of a feature of the meta-information that is previously acquired and a feature of the meta-information of the sensor data that is a determination target. As a result, the usefulness of the sensor data can be easily determined without specifying the context of the sensor data.

For example, in a case where a determination condition that the meta-information of the sensor data that is the determination target has a feature that the meta-information that is previously acquired does not have is satisfied, the information processing device 100 determines that the corresponding sensor data is useful. As a specific example in a case where the meta-information is assumed to be a time stamp, in a case where the information processing device 100 acquires a time stamp associated with the sensor data as the meta-information of the sensor data, the information processing device 100 handles a date, time, or the like included in the time stamp as a feature of the sensor data. Note that the present invention is not limited to this example, and the time stamp may be period information (for example, HH:00 to hh:00, DD/MM), simple logic information for specifying a time (for example, an inequation such as X>5), or the like. Then, in a case where there is no data sample corresponding to the time stamp (date, time, or the like) of the sensor data acquired as the meta-information among data samples of the sensor data managed by the information processing device 100, the information processing device 100 can determine that the corresponding sensor data is useful. Thus, the usefulness of the sensor data can be easily determined. Furthermore, for example, in a case where it is assumed that machine learning is performed using the collected sensor data, it is possible to efficiently collect a sample of answer data corresponding to a situation where learning has not been performed.

Furthermore, in a case where a determination condition that the meta-information of the sensor data that is the determination target has relatively few features as features that the meta-information that is previously acquired has is satisfied, the information processing device 100 determines that the corresponding sensor data is useful. As a specific example in a case where the meta-information is assumed to be a time stamp, in a case where, among the data samples of the sensor data managed by the information processing device 100, a data sample corresponding to the time stamp (date, time, or the like) of the sensor data acquired as the meta-information is not sufficiently present in the sensor data managed by the information processing device 100 (in a case where the number of samples is insufficient), the information processing device 100 can determine that the corresponding sensor data is useful. Thus, the usefulness of the sensor data can be easily determined. Furthermore, for example, in a case where it is assumed that machine learning is performed using the collected sensor data, it is possible to efficiently supplement a sample of answer data corresponding to a situation where learning has not been performed.

The information processing device 100 transmits, to the terminal device 10, a provision request for requesting transmission of the sensor data, according to the usefulness determination result based on the meta-information (Step S13). For example, in a case where it is determined that the sensor data is useful as a result of the determination of the usefulness based on the meta-information, the information processing device 100 transmits, to the terminal device 10x, a provision request for requesting the terminal device 10x to transmit the corresponding sensor data. Note that, although a form in which the meta-information is actively transmitted from the terminal device 10x to the information processing device 100 (so-called push type) has been described in the above-described example, a form in which the meta-information is transmitted in response to a request from the information processing device 100 (so-called pull type) may also be applied.

As described above, the information processing device 100 according to the embodiment determines the usefulness of the sensor data associated with the meta-information on the basis of the meta-information of the sensor data acquired from the terminal device 10x. Then, in a case where it is determined that the sensor data is useful, the information processing device 100 according to the embodiment requests the terminal device 10x to transmit the sensor data. As a result, the information processing device 100 according to the embodiment can selectively collect useful sensor data. Furthermore, with the information processing device 100 according to the embodiment, useful sensor data can be selectively collected, and as a result, the cost of the entire system required for transmission and reception of sensor data can be reduced.

### 2. Configuration of System

An example of a configuration of the information processing system 1 including the information processing device 100 according to the embodiment will be described with reference to FIG. 2. FIG. 2 is a diagram illustrating an example of a configuration of the information processing system according to the embodiment. Note that although FIG. 2 illustrates the configuration of the information processing system 1 according to the embodiment, the configuration of the information processing system 1 according to the embodiment is not limited to that illustrated in FIG. 2, and the information processing system 1 may include more devices than the example illustrated in FIG. 2.

As illustrated in FIG. 2, the information processing system 1 according to the embodiment includes a plurality of terminal devices 10 and the information processing device 100. The plurality of terminal devices 10 and the information processing device 100 are each connected to a network N in a wired or wireless manner. The network N is a communication network such as a local area network (LAN), a wide area network (WAN), a telephone network (a mobile telephone network, a fixed telephone network, or the like), a regional Internet protocol (IP) network, or the Internet. The network N may include a wired network or a wireless network. The plurality of terminal devices 10 and the information processing device 100 can communicate with each other through the network N.

The terminal devices 10 (10x, 10y, and 10z) are devices that transmit sensor data acquired by the sensor group (for example, the sensor group 11x illustrated in FIG. 1) to the information processing device 100. The terminal device 10 is typically a smartphone. The terminal device 10 may be any information processing device such as various types of personal computers (PCs) including a desktop PC, a notebook PC, and a tablet PC, a mobile phone, a personal digital assistant (PDA), or a wearable device.

Furthermore, the terminal device 10 includes a GPS receiver, an acceleration sensor, or the like embedded therein as the sensor group (for example, the sensor group 11x illustrated in FIG. 1). For example, the terminal device 10 causes the GPS receiver to periodically measure a current position on the basis of radio waves received from GPS satellites, and stores position information indicating the measured position as the sensor data in association with the date and time of measurement. Furthermore, the terminal device 10 causes the acceleration sensor to detect an acceleration acting on the terminal device 10, and stores the detected acceleration as the sensor data in association with the date and time of detection.

Furthermore, the terminal device 10 transmits the meta-information regarding the sensor data to the information processing device 100 at a predetermined timing. Examples of the meta-information include, in addition to date and time information (time stamp) associated with the sensor data, various pieces of information that can be evoked as the context of the user Ua that can be acquired and determined by the terminal device 10x on the basis of the sensor information, such as the location (for example, address) associated with the sensor data and the behavior state associated with the sensor data. Note that the context includes a state of the user Ua. As a specific example, a time stamp “8:00 on Tuesday, March 9” is information that can be the meta-information regarding the sensor data, an address “Kasumigaseki, Chiyoda-ku, Tokyo” is information that can be the meta-information regarding the sensor data, and “running along a river away from home” is also information that can be the meta-information regarding the sensor data. Furthermore, position information associated with the time stamp “8:00 on Tuesday, March 9”, an acceleration associated with the context “running along a river away from home”, and the like can be sensor data associated with the meta-information. Furthermore, the terminal device 10 can transmit the meta-information to the information processing device 100 at a different timing for each sensor data. Furthermore, the terminal device 10 may transmit the meta-information regarding the sensor data to the information processing device 100 in response to a request from the information processing device 100. The terminal device 10 acquires date and time information (time stamp) associated with the position information and the acceleration as the meta-information, and transmits the date and time information to the information processing device 100.

Furthermore, in a case where the terminal device 10 acquires sensor data including a plurality of time-series data samples, determination data randomly extracted from the sensor data may be transmitted to the information processing device 100 together with the meta-information.

The information processing device 100 is a device that collects the sensor data from the plurality of terminal devices 10, and is typically a server device. The information processing device 100 receives the meta-information regarding the sensor data, the sensor data, and the like transmitted from the terminal device 10 via the network N.

### 3. Configuration of Information Processing Device

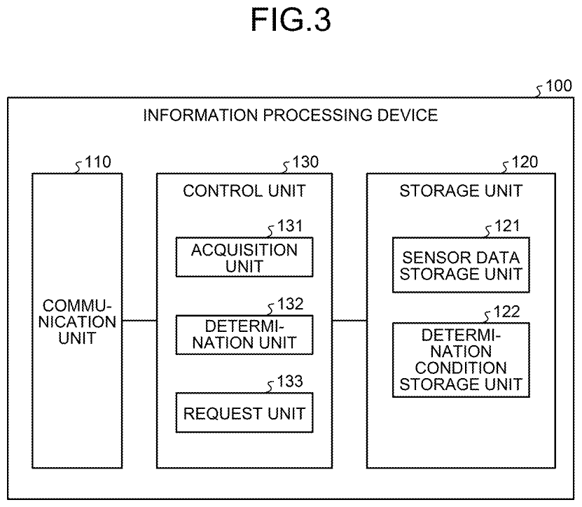

Next, a configuration of the information processing device 100 according to the embodiment will be described with reference to FIG. 3. FIG. 3 is a diagram illustrating an example of the configuration of the information processing device according to the embodiment.

As illustrated in FIG. 3, the information processing device 100 includes a communication unit 110, a storage unit 120, and a control unit 130. Note that although FIG. 3 illustrates an example of the configuration of the information processing device 100, the configuration of the information processing device 100 is not limited to the configuration illustrated in FIG. 3, and other functional units other than those illustrated in FIG. 3 may be included.

Communication Unit 110

The communication unit 110 is connected to the network N in a wired or wireless manner, for example, and transmits and receives information to and from other devices via the network N. The communication unit 110 is implemented by, for example, a network interface card (NIC), an antenna, or the like. The network N is a communication network such as a local area network (LAN), a wide area network (WAN), a telephone network (a mobile telephone network, a fixed telephone network, or the like), a regional Internet protocol (IP) network, or the Internet. The network N may include a wired network or a wireless network.

Storage Unit 120

The storage unit 120 is implemented by, for example, a semiconductor memory element such as a random access memory (RAM) or a flash memory, or a storage device such as a hard disk or an optical disk. As illustrated in FIG. 3, the storage unit 120 includes a sensor data storage unit 121 and a determination condition storage unit 122.

Sensor Data Storage Unit 121

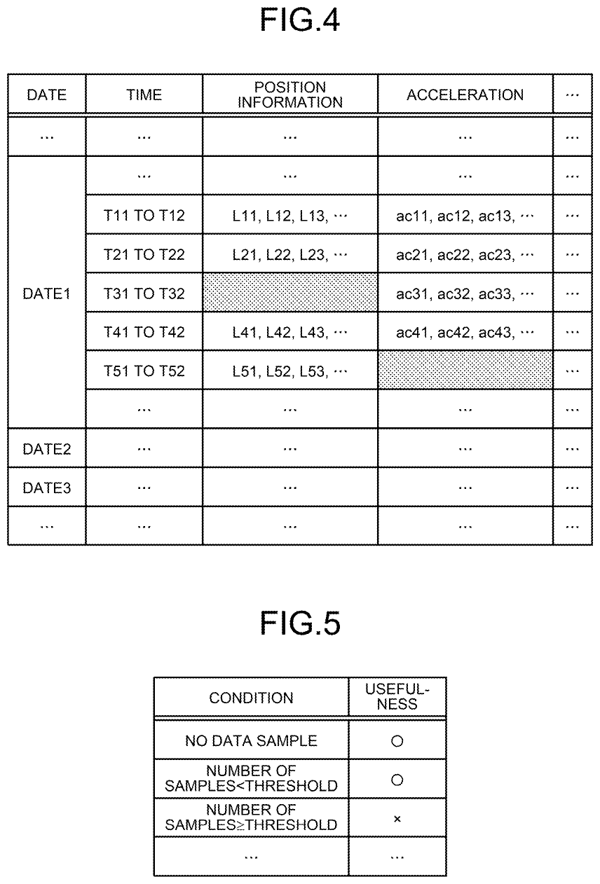

The sensor data storage unit 121 stores the sensor data acquired from each terminal device 10. FIG. 4 is a diagram illustrating an example of the sensor data according to the embodiment. Note that FIG. 4 illustrates an overview of the sensor data stored in the sensor data storage unit 121, but the sensor data does not have to be configured in the form illustrated in FIG. 4.

As illustrated in FIG. 4, the sensor data stored in the sensor data storage unit 121 includes an item “date”, an item “time”, an item “position information”, an item “acceleration”, and the like. In the sensor data, these items are associated with each other.

In the item “date”, date information associated with the sensor data is stored. For example, in a case of the position information, information regarding a date when the position information is measured in the terminal device 10 is stored, and in a case of the acceleration, information regarding a date when the acceleration is detected in the terminal device 10 is stored.

In the item “time”, time information associated with the sensor data is stored. For example, in a case of the position information, information regarding a time when the position information is measured in the terminal device 10 is stored, and in a case of the acceleration, information regarding a time when the acceleration is detected in the terminal device 10 is stored. The information stored in the item “time” is included in date and time information (time stamp) corresponding to the sensor data together with the information stored in the item “date” described above.

In the item “position information”, information regarding the position of the terminal device 10 acquired as the sensor data from the terminal device 10 is stored.

In the item “acceleration”, information regarding an acceleration acting on the terminal device 10 acquired as the sensor data from the terminal device 10 is stored.

In the example illustrated in FIG. 4, position information [L11, L12, L13, . . . ], accelerations [ac11, ac12, ac13, . . . ], and the like measured between times [T11 to T12] of a date [DATE 1] are stored.

In the example illustrated in FIG. 4, position information corresponding to times [T11 to T12] of the date [DATE 1] is not stored, and accelerations corresponding to times [T51 to T52] of the date [DATE 1] is not stored.

Determination Condition Storage Unit 122

The determination condition storage unit 122 stores a determination condition for determining the usefulness of the sensor data. FIG. 5 is a diagram illustrating an example of the determination condition according to the embodiment. Note that FIG. 5 illustrates an overview of the determination condition stored in the determination condition storage unit 122, and the determination condition may actually be described as data that can be interpreted by the information processing device 100.

As illustrated in FIG. 5, the determination condition stored in the determination condition storage unit 122 is configured by associating an item “condition” with an item “usefulness”.

In the item “condition”, a condition for determining whether or not the sensor data is useful on the basis of the meta-information regarding the sensor data is stored. In the example illustrated in FIG. 5, conditions such as “no data sample”, “number of samples<threshold”, and “number of samples≥threshold” are defined as the item “condition”.

In the item “usefulness”, information regarding whether or not it is determined that the sensor data that is the determination target is useful in a case where the condition defined in the item “condition” is satisfied is stored. In the example illustrated in FIG. 5, a symbol “∘” or “x” is assigned to the item “usefulness”. “∘” means that it is determined that the sensor data is useful, and “x” means that it is determined that the sensor data is not useful.

The condition “no data sample” corresponds to a case where there is no data sample corresponding to sensor data that is the usefulness determination target in the pieces of sensor data stored in the sensor data storage unit 121. In addition, in the item “usefulness”, “∘” indicating that it is determined that the corresponding sensor data is useful is associated with the condition “no data sample”.

A corresponding case of “no data sample” will be specifically described. For example, in a case where a data sample corresponding to date and time information (date and time) acquired as the meta-information of the sensor data that is the determination target does not exist in the pieces of sensor data stored in the sensor data storage unit 121, it is determined that the corresponding sensor data is useful.

The condition “number of samples<threshold” corresponds to a case where the number of data samples corresponding to the sensor data that is the usefulness determination target in the pieces of sensor data stored in the sensor data storage unit 121 is not sufficient (a case where the number of data samples is less than a threshold). In addition, in the item “usefulness”, “∘” indicating that it is determined that the corresponding sensor data is useful is associated with the condition “no data sample”.

A corresponding case of “number of samples<threshold” will be specifically described. For example, in a case where the number of data samples corresponding to date and time information (date and time) acquired as the meta-information of the sensor data that is the determination target in the pieces of sensor data stored in the sensor data storage unit 121 is not sufficient and it is thus necessary to supplement the sample, it is determined that the corresponding sensor data is useful.

The condition “number of samples≥threshold” corresponds to a case where the number of data samples corresponding to the sensor data that is the usefulness determination target in the pieces of sensor data stored in the sensor data storage unit 121 is sufficient (a case where the number of data samples is equal to or larger than the threshold). In addition, in the item “usefulness”, “x” indicating that it is determined that the corresponding sensor data is not useful is associated with the condition “no data sample”.

A corresponding case of “number of samples≥threshold” will be specifically described. For example, in a case where the number of data samples corresponding to date and time information (date and time) acquired as the meta-information of the sensor data that is the determination target in the pieces of sensor data stored in the sensor data storage unit 121 is sufficient and it is thus not necessary to supplement the sample, it is determined that the corresponding sensor data is useful.

Note that the usefulness determination condition can include not only a quantitative condition such as whether the amount of sensor data associated with the corresponding meta-information is large or small, whether the sensor data associated with the corresponding meta-information is old or new, whether the sensor data associated with the corresponding meta-information is rough or detailed, or whether the sensor data associated with the corresponding meta-information has high accuracy or low accuracy, but also a condition according to a demand (need) for the corresponding meta-information. Furthermore, the usefulness determination condition is not limited to a case of being defined as a statically fixed condition, and may be a condition that can be dynamically changed. For example, in a case where analysis for a certain context is required, it may be determined that usefulness of sensor data associated with the certain context is high according to an increase in demand as a data sample, and it may be determined that usefulness of sensor data associated with a context having no demand as a data sample is low.

Control Unit 130

Returning to FIG. 3, the control unit 130 is a controller that controls the information processing device 100. The control unit 130 is implemented by executing various programs (for example, the information processing program) stored in a storage device in the information processing device 100 using a RAM as a work area by a central processing unit (CPU), a micro processing unit (MPU), or the like. In addition, the control unit 130 may be implemented by, for example, an integrated circuit such as an application specific integrated circuit (ASIC) or a field programmable gate array (FPGA).

As illustrated in FIG. 3, the control unit 130 includes an acquisition unit 131, a determination unit 132, and a request unit 133. The control unit 130 implements or executes a function and an action of information processing to be described later by the respective units. Note that an internal configuration of the control unit 130 is not limited to a configuration illustrated in FIG. 3, and may be another configuration as long as it is a configuration for performing information processing to be described later. In addition, a connection relationship between respective units included in the control unit 130 is not limited to a connection relationship illustrated in FIG. 3, and may be another connection relationship. Note that the control unit 130 may include a reception unit that acquires various types of information such as the sensor data and the meta-information regarding the sensor data from the terminal device 10 via the network N, separately from the acquisition unit 131.

Acquisition Unit 131

The acquisition unit 131 acquires the meta-information regarding the sensor data from the terminal device 10. A time stamp including a date and time is exemplified as the meta-information. For example, the acquisition unit 131 can acquire the meta-information transmitted from the terminal device 10 at a predetermined timing via the communication unit 110. Further, the acquisition unit 131 can acquire the meta-information at an arbitrary timing by transmitting a request for requesting transmission of the meta-information to the terminal device 10 via the communication unit 110. The acquisition unit 131 transmits the acquired meta-information to the determination unit 132.

Determination Unit 132

The determination unit 132 determines the usefulness of the sensor data on the basis of the meta-information acquired by the acquisition unit 131. Specifically, the determination unit 132 determines the usefulness of the sensor data on the basis of a feature of the meta-information that is previously acquired and a feature of the meta-information of the sensor data that is the determination target. For example, in a case where the meta-information of the sensor data that is the determination target has a feature that the meta-information that is previously acquired does not have, the determination unit 132 determines that the sensor data is useful. Furthermore, for example, in a case where the meta-information of the sensor data that is the determination target has relatively few features as features that the meta-information that is previously acquired has, the determination unit 132 determines that the sensor data is useful. The determination unit 132 transmits a result of determination of the usefulness of the sensor data to the request unit 133.

A specific example of the determination processing performed by the determination unit 132 in a case where the meta-information is assumed to be a time stamp will be described. In a case where a data sample corresponding to date and time information (date and time) acquired as the meta-information of the sensor data that is the determination target does not exist in the pieces of sensor data stored in the sensor data storage unit 121, the determination unit 132 determines that, among the determination conditions defined in advance, the condition “no data sample” is satisfied, and the sensor data that is the determination target is useful.

Further, in a case where the number of data samples corresponding to date and time information (date and time) acquired as the meta-information of the sensor data that is the determination target in the pieces of sensor data stored in the sensor data storage unit 121 is not sufficient and it is thus necessary to supplement the sample, the determination unit 132 determines that, among the determination conditions defined in advance, the condition “number of samples<threshold” is satisfied, and the sensor data that is the determination target is useful.

Meanwhile, in a case where the number of data samples corresponding to date and time information (date and time) acquired as the meta-information of the sensor data that is the determination target in the pieces of sensor data stored in the sensor data storage unit 121 is sufficient and it is thus not necessary to supplement the sample, the determination unit 132 determines that, among the determination conditions defined in advance, the condition “number of samples≥threshold” is satisfied, and the sensor data that is the determination target is not useful.

In a case where the determination unit 132 determines that the sensor data is useful, the request unit 133 requests transmission of the sensor data. For example, the request unit 133 transmits a request for requesting transmission of the sensor data to the terminal device 10 via the communication unit 110.

### 4. Processing Procedure

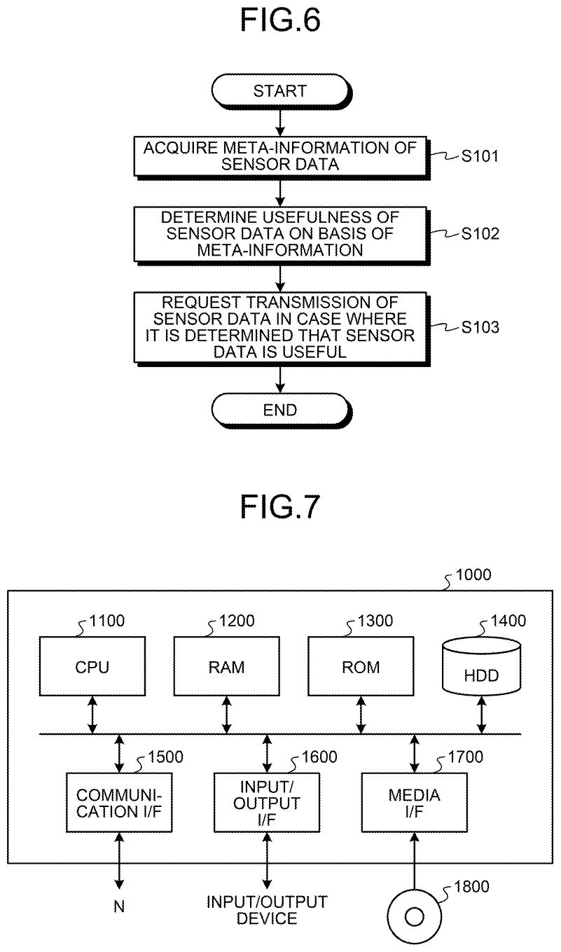

Hereinafter, a processing procedure performed by the information processing device 100 according to the embodiment will be described with reference to FIG. 6. FIG. 6 is a flowchart illustrating an example of the processing procedure performed by the information processing device according to the embodiment. The processing procedure illustrated in FIG. 6 is performed by the control unit 130 of the information processing device 100. The processing procedure illustrated in FIG. 6 is repeatedly performed while the information processing device 100 is in operation.

As illustrated in FIG. 6, the acquisition unit 131 acquires the meta-information regarding the sensor data from the terminal device 10 (Step S101). The acquisition unit 131 transmits the acquired meta-information to the determination unit 132.

Furthermore, the determination unit 132 determines the usefulness of the sensor data on the basis of the meta-information acquired by the acquisition unit 131 (Step S102). For example, the determination unit 132 can determine the usefulness of the sensor data according to the determination condition stored in the determination condition storage unit 122. The determination unit 132 determines the usefulness of the sensor data on the basis of a feature of the meta-information that is previously acquired and a feature of the meta-information of the sensor data that is the determination target. For example, in a case where the meta-information of the sensor data that is the determination target has a feature that the meta-information that is previously acquired does not have, the determination unit 132 determines that the sensor data is useful. Furthermore, for example, in a case where the meta-information of the sensor data that is the determination target has relatively few features as features that the meta-information that is previously acquired has, the determination unit 132 determines that the sensor data is useful. The determination unit 132 transmits a result of determination of the usefulness of the sensor data to the request unit 133.

Furthermore, in a case where the determination unit 132 determines that the sensor data is useful, the request unit 133 requests transmission of the sensor data (Step S103), and the processing procedure illustrated in FIG. 6 ends.

### 5. Modified Example

The information processing device 100 according to the above-described embodiment may be implemented in various different modes other than the above-described embodiment. Therefore, a modified example of the embodiment according to the information processing device 100 described above will be described below.

5-1. Use of Determination Data

In the above-described embodiment, in a case where the information processing device 100 determines the usefulness of the sensor data including a plurality of data samples acquired in time series, determination data for determining the usefulness of the sensor data may be acquired from the terminal device 10. For example, the terminal device 10 randomly extracts the determination data from the sensor data including 60 data samples measured every minute “from 10:10 on February 1 to 11:10 on February 1”, and transmits the determination data to the information processing device 100. The information processing device 100 determines usefulness of the determination data received from the terminal device 10, determines that the entire sensor data is useful in a case where it is determined that the determination data is useful, and requests the terminal device 10 to transmit the sensor data.

5-2. Determination of Usefulness

In the above-described embodiment, an example in which the information processing device 100 determines the usefulness of the sensor data on the basis of the meta-information regarding the sensor data has been described, but the present invention is not limited to this example. For example, the information processing device 100 may determine the usefulness of the sensor data on the basis of a determination value indicating the rarity of the sensor data determined in the terminal device 10.

An example of a method of calculating the determination value indicating the rarity of the sensor data in the terminal device 10 will be described. For example, in a case of calculating the determination value corresponding to the position information acquired as the sensor data, the terminal device 10 evaluates the rarity of the position information that is a determination target for the user of the terminal device 10. For example, it is conceivable to evaluate whether or not the position information is rare on the basis of a frequency at which the corresponding position information is recorded within the most recent predetermined period recorded in the terminal device 10. For example, it can be evaluated that a rarity value of the position information is higher as the frequency of recording is lower. In this case, the terminal device 10 may associate the determination value whose score becomes higher as the rarity value is higher with the position information. Note that the position information does not need to be exactly matched, and position information included in a predetermined area may be regarded as the same position information.

Furthermore, in a case of calculating the determination value corresponding to the acceleration acquired as the sensor data, the terminal device 10 evaluates the rarity of the acceleration that is the determination target for the user of the terminal device 10. It is conceivable to evaluate whether or not the acceleration is rare on the basis of, for example, a user event registered in a schedule. For example, it is evaluated that an acceleration associated with a holding timing of a user event that is less likely to be registered in the schedule as the user event, such as participation in the triathlon, has a higher rare value. In this case, the terminal device 10 may associate the determination value whose score becomes higher as the rarity value is higher with the acceleration.

The terminal device 10 can transmit, to the information processing device 100, the determination value as described above as the meta-information of the position information acquired as the sensor data.

The information processing device 100 determines the usefulness of the sensor data associated with the determination value on the basis of the determination value acquired as the meta-information from the terminal device 10. For example, in a case where the determination value exceeds a threshold, the information processing device 100 determines that the sensor data is useful and requests the terminal device 10 to transmit the sensor data.

Note that, in a case where the information processing device 100 determines the usefulness of the sensor data including a plurality of data samples acquired in time series, the determination data for determining the usefulness of the sensor data may be acquired from the terminal device 10. For example, the terminal device 10 randomly extracts the determination data from the sensor data including 60 data samples measured every minute “from 10:10 on February 1 to 11:10 on February 1”, and transmits the determination data to the information processing device 100. The information processing device 100 determines usefulness of the determination data received from the terminal device 10, determines that the entire sensor data is useful in a case where it is determined that the determination data is useful, and requests the terminal device 10 to transmit the sensor data.

### 6. Hardware Configuration

The information processing device 100 according to the embodiment and the modified example is implemented by, for example, a computer 1000 having a configuration as illustrated in FIG. 8. FIG. 8 is a hardware configuration diagram illustrating an example of the computer that implements functions of the information processing device according to the embodiment and the modified example.

The computer 1000 includes a CPU 1100, a RAM 1200, a read only memory (ROM) 1300, a hard disk drive (HDD) 1400, a communication interface (I/F) 1500, an input/output interface (I/F) 1600, and a media interface (I/F) 1700.

The CPU 1100 is operated on the basis of a program stored in the ROM 1300 or the HDD 1400, and controls each unit. The ROM 1300 stores a boot program executed by the CPU 1100 when the computer 1000 is activated, a program depending on hardware of the computer 1000, and the like.

The HDD 1400 stores a program executed by the CPU 1100, data used by the program, and the like. The communication interface 1500 receives data from other devices via the network (communication network) N, transmits the data to the CPU 1100, and transmits data generated by the CPU 1100 to other devices via the network (communication network) N.

The CPU 1100 controls an output device such as a display or a printer, and an input device such as a keyboard or a mouse via the input/output interface 1600. The CPU 1100 acquires data from the input device via the input/output interface 1600. In addition, the CPU 1100 outputs the generated data to the output device via the input/output interface 1600.

The media interface 1700 reads a program or data stored in a recording medium 1800 and provides the program or data to the CPU 1100 via the RAM 1200. The CPU 1100 loads the program from the recording medium 1800 onto the RAM 1200 via the media interface 1700, and executes the loaded program. Note that the recording medium 1800 is, for example, an optical recording medium such as a digital versatile disc (DVD) or a phase change rewritable disk (PD), a magneto-optical recording medium such as a magneto-optical disk (MO), a tape medium, a magnetic recording medium, a semiconductor memory, or the like.

For example, in a case where the computer 1000 functions as the information processing device 100 according to the embodiment, the CPU 1100 of the computer 1000 implements a function of the control unit 130 by executing the program loaded onto the RAM 1200. In addition, the HDD 1400 stores data in the storage unit 120. The CPU 1100 of the computer 1000 reads these programs from the recording medium 1800 and executes the programs, but as another example, these programs may be acquired from another device via a network (communication network) N.

### 7. Others

All or some types of processing described as being automatically performed among the types of processing described in the embodiment and the modified example described above can be manually performed or all or some types of processing described as being manually performed among the types of processing described in the embodiment and the modified example described above can be automatically performed by a known method. In addition, processing procedures, specific names, and information including various data or parameters illustrated in the above document or the drawings can be arbitrarily changed unless otherwise specified.

In the embodiment and the modified example described above, in order to implement the information processing method performed by the information processing device 100 (see FIG. 6), the processing function corresponding to each unit (the acquisition unit 131, the determination unit 132, and the request unit 133) of the control unit 130 included in the information processing device 100 may be implemented as an add-on to the information processing program installed in advance in the information processing device 100, or may be implemented by flexibly describing the processing function as a dedicated information processing program using a lightweight programming language or the like.

In addition, each component of the respective devices that are illustrated is a functional concept, and does not necessarily have to be physically configured as illustrated. That is, specific forms of distribution and integration of the respective devices are not limited to those illustrated, and all or some of the respective devices can be configured to be functionally or physically distributed and integrated in any units according to various loads, use situations, or the like.

In addition, the embodiment and the modified example described above can be appropriately combined with each other as long as processing contents do not contradict each other.

### 8. Effect

The information processing device 100 according to the embodiment or the modified example described above includes the acquisition unit 131, the determination unit 132, and the request unit 133. The acquisition unit 131 acquires the meta-information regarding the sensor data from the terminal device 10. The determination unit 132 determines the usefulness of the sensor data on the basis of the meta-information acquired by the acquisition unit 131. In a case where the determination unit 132 determines that the sensor data is useful, the request unit 133 requests transmission of the sensor data.

In this manner, the information processing device 100 according to the embodiment or the modified example can selectively collect useful sensor data. Furthermore, with the information processing device 100 according to the embodiment or the modified example, useful sensor data can be selectively collected, and as a result, the cost of the entire system required for transmission and reception of sensor data can be reduced.

Furthermore, in the information processing device 100 according to the embodiment or the modified example, the determination unit 132 determines the usefulness of the sensor data on the basis of a feature of the meta-information that is previously acquired and a feature of the meta-information of the sensor data that is a determination target. As a result, the information processing device 100 according to the embodiment or the modified example can easily determine the usefulness of the sensor data without specifying the context of the sensor data.

Furthermore, in the information processing device 100 according to the embodiment or the modified example, in a case where the meta-information of the sensor data that is the determination target has a feature that the meta-information that is previously acquired does not have, the determination unit 132 determines that the sensor data is useful. As a result, the information processing device 100 according to the embodiment or the modified example can easily determine the usefulness of the sensor data. Furthermore, for example, in a case where it is assumed that machine learning is performed using the collected sensor data, it is possible to efficiently collect a sample of answer data corresponding to a situation where learning has not been performed.

Furthermore, in the information processing device 100 according to the embodiment or the modified example, in a case where the meta-information of the sensor data that is the determination target has relatively few features as features that the meta-information that is previously acquired has, the determination unit 132 determines that the sensor data is useful. As a result, the information processing device 100 according to the embodiment or the modified example can easily determine the usefulness of the sensor data. Furthermore, for example, in a case where it is assumed that machine learning is performed using the collected sensor data, it is possible to efficiently supplement a sample of answer data corresponding to a situation where learning has not been performed.

Furthermore, in the information processing device 100 according to the embodiment or the modified example, the meta-information is a time stamp associated with the sensor data. As a result, useful data can be collected from among the pieces of sensor data acquired in time series.

Although some of the embodiments of the present application have been described in detail with reference to some of the drawings hereinabove, these are examples, and it is possible to carry out the present invention in other modes in which various modifications and improvements have been made based on knowledge of those skilled in the art, including aspects described in a section of the disclosure of the present invention.

In addition, the “section”, the “module”, and the “unit” described above can be replaced with a “means”, a “circuit”, or the like. For example, the determination unit can be replaced with a determination means or a determination circuit.

According to an aspect of the embodiment, it is possible to selectively collect useful sensor data.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

1. An information processing device comprising:
an acquisition unit that acquires meta-information regarding sensor data from a terminal device;
a determination unit that determines usefulness of the sensor data on a basis of the meta-information acquired by the acquisition unit; and
a request unit that requests transmission of the sensor data in a case where the determination unit determines that the sensor data is useful.

2. The information processing device according to claim 1, wherein
the determination unit
determines the usefulness of the sensor data on a basis of a feature of the meta-information that is previously acquired and a feature of the meta-information of the sensor data that is a determination target.

3. The information processing device according to claim 2, wherein
in a case where the meta-information of the sensor data that is the determination target has a feature that the meta-information that is previously acquired does not have, the determination unit determines that the sensor data is useful.

4. The information processing device according to claim 1, wherein
in a case where the meta-information of the sensor data that is the determination target has relatively few features as features that the meta-information that is previously acquired has, the determination unit determines that the sensor data is useful.

5. The information processing device according to claim 1, wherein
the meta-information is a context associated with the sensor data.

6. The information processing device according to claim 5, wherein
the context includes a time stamp, a location, and a behavior state associated with the sensor data.

7. An information processing method performed by a computer, the information processing method comprising:
an acquisition step of acquiring meta-information regarding sensor data from a terminal device;
a determination step of determining usefulness of the sensor data on a basis of the meta-information acquired by the acquisition step; and
a request step of requesting transmission of the sensor data in a case where it is determined in the determination step that the sensor data is useful.

8. An information processing program causing a computer to perform:
an acquisition procedure of acquiring meta-information regarding sensor data from a terminal device;
a determination procedure of determining usefulness of the sensor data on a basis of the meta-information acquired by the acquisition procedure; and
a request procedure of requesting transmission of the sensor data in a case where it is determined in the determination procedure that the sensor data is useful.
